(19) United States
(12) Patent Application Publication
(10) Pub. No.: US 2025/0046148 A1
(43) Pub. Date: Feb. 6, 2025

(54) GAMING MACHINE AND ARRANGEMENTS OF GAMING MACHINES WHICH REDUCE OCCUPIED CASINO FLOOR SPACE

(71) Applicant: AGS LLC, Las Vegas, NV (US)

(72) Inventor: Ryan Patrick Rye, Suwanee, GA (US)

(21) Appl. No.: 18/228,180

(22) Filed: Jul. 31, 2023

(51) Int. Cl. G07F 17/32

(52) U.S. Cl. CPC G07F 17/3216

(57) ABSTRACT

Gaming machines, housings or cabinets for gaming machines, and arrangements of gaming machines are configured to minimize the amount of casino floor space occupied thereby. Gaming machines are configured so that, when located adjacent to one another, an increased number of gaming machines can be located in a designated amount of casino floor space, such as where a width of the gaming machine is reduced, or where a width of a housing of the gaming machine is reduced in relation to a video display thereof, and/or where the gaming machine has a generally trapezoidal cross-sectional shape which allows gaming machines to be arranged in overlapping reverse configuration.

### FIELD

The present disclosure relates to gaming machines and housings or cabinets therefor.

### BACKGROUND

Casino-style gaming machines have evolved from mechanical spinning reel machines to having one or more video displays for displaying games, including slot-style games, poker or other games. While there are various configurations of gaming machines, including video-type gaming machines with a single display, multiple displays (such as a main display and a secondary display or a display associated with a top box), or displays having different shapes such as curved, a common aspect of gaming machines is the use of a cabinet or housing of a relatively standard size. In particular, while the height of gaming machines may vary, particularly depending upon the configuration of the video displays, most cabinets have a width of around 28 inches.

Because players are always seeking new and exciting games, casinos continue to seek to place new gaming machines on their casino floors. However, with floor space limited, this generally requires that the casino make the difficult choice of removing one gaming machine (an old one) with a new one. This decision can be perilous, because the casino risks that the new machine may not perform as well as the one it is replacing.

Another problem that casinos face is that certain games are sometimes highly popular. The casino may wish to add a larger number of those machines, which again forces the casino to consider removing other machines.

Solutions to these and other problems relating to the configuration of gaming machines, are desired.

### SUMMARY

Aspects of the disclosure comprise gaming machines, housings or cabinets for gaming machines, and arrangements of gaming machines which are configured to minimize the amount of casino floor space occupied thereby. Gaming machines may be configured so that, when located adjacent to one another, an increased number of gaming machines can be located in a designated amount of casino floor space.

As examples of the disclosure, a gaming machine has a reduced width, such as 50% of the width of a standard gaming machine. In some examples, a width of a cabinet or housing of the gaming machine is reduced in relation to a video display thereof, and/or the gaming machine/cabinet may have a generally trapezoidal horizontal cross-sectional shape.

In accordance with the disclosure, gaming machines may be placed in rows where the gaming machines alternately face in opposing directions. The gaming machines may also be placed in circular banks or in other groupings, wherein the configuration of the gaming machines and their arrangement results in less floor space being occupied by the gaming machines as compared to standard gaming machines.

Further objects, features, and advantages of the present disclosure over the prior art will become apparent from the detailed description of the drawings which follows, when considered with the attached figures.

### DESCRIPTION OF THE DRAWINGS

FIG. 1 is a front perspective view of an example of a gaming machine in accordance with the present disclosure;

FIG. 2 is a rear perspective view of the gaming machine illustrated in FIG. 1;

FIG. 3 is a front view of the gaming machine illustrated in FIG. 1;

FIG. 4 is a first side view of the gaming machine illustrated in FIG. 1;

FIG. 5 is a partial cut-away view of the gaming machine illustrated in FIG. 4 with top and bottom doors shown in an open position;

FIG. 6 is a partial cut-away front perspective view of the gaming machine illustrated in FIG. 1 with a top door shown in an open position;

FIGS. 7A and B illustrate another example gaming machine of the present disclosure;

FIG. 8A illustrates a configuration of gaming machines in accordance the prior art and FIGS. 8B and 8C illustrate a configuration of gaming machines in accordance with the present disclosure;

FIG. 9A illustrates another configuration of gaming machines in accordance the prior art and FIG. 9B illustrates another configuration of gaming machines in accordance with the present disclosure;

FIGS. 10A and B illustrate another example gaming machine of the present disclosure;

FIGS. 11A and B illustrate another example gaming machine of the present disclosure;

FIGS. 12A and B illustrate another example gaming machine of the present disclosure;

FIGS. 13A and B illustrate another example gaming machine of the present disclosure;

FIG. 14A illustrates another configuration of gaming machines in accordance the prior art and FIG. 14B illustrates another configuration of gaming machines in accordance with the present disclosure;

FIG. 14C illustrates another configuration of gaming machines in accordance with the present disclosure;

FIG. 15A illustrates a configuration of gaming machines in accordance the prior art and FIG. 15B illustrate a configuration of gaming machines in accordance with the present disclosure;

FIG. 15C illustrates yet another configuration of gaming machines in accordance with the disclosure in relation to gaming machines of the prior art; and

FIGS. 16A and B illustrate yet another configuration of gaming machines in accordance with the present disclosure.

### DETAILED DESCRIPTION

In the following description, numerous specific details are set forth in order to provide a more thorough description of the present disclosure. It will be apparent, however, to one skilled in the art, that the present disclosure may be practiced without these specific details. In other instances, well-known features have not been described in detail so as not to obscure the disclosure.

Aspects of the disclosure comprise gaming machines, housings or cabinets for gaming machines, and arrangements of gaming machines. In one example of the disclosure, a gaming machine has a configuration which minimizes the amount of casino floor space occupied thereby. In certain examples of the disclosure, multiple gaming machines are configured so that, when located adjacent to one another, an increased number of gaming machines can be located in a designated amount of casino floor space.

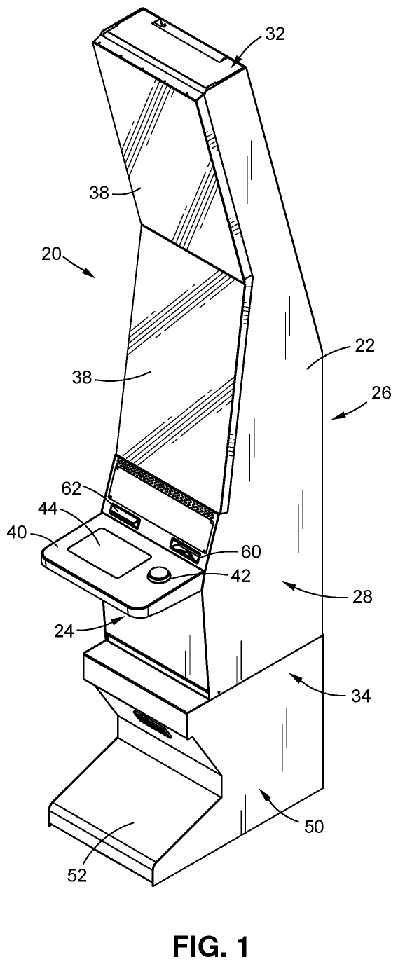

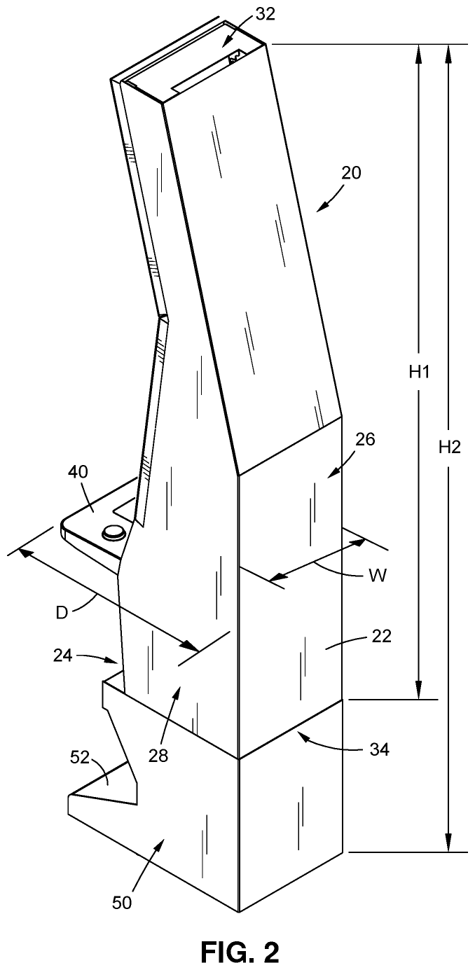

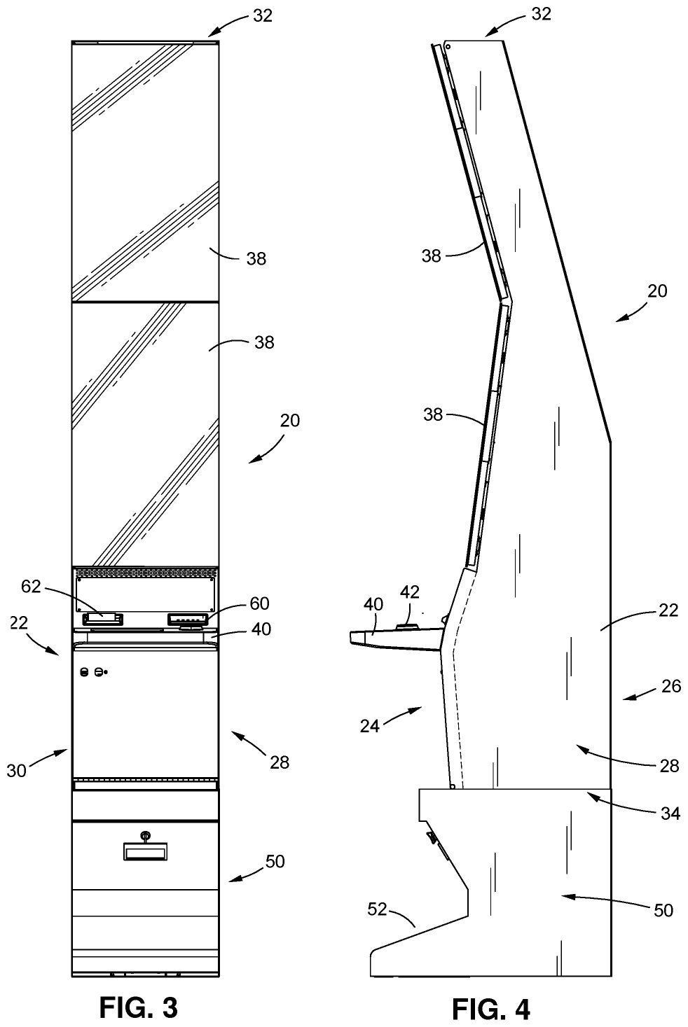

One example of the disclosure will be described with reference to FIGS. 1-6. As illustrated in FIGS. 1 and 2, a gaming machine 20 has a cabinet or housing 22, such as for housing and/or supporting a number of components of the gaming machine. The cabinet 22 has a front 24 which generally defines a front of the gaming machine 20, an opposing back or rear 26, a first side 28 and an opposing second side 30. The cabinet 22 also has a top 32 and a bottom 34.

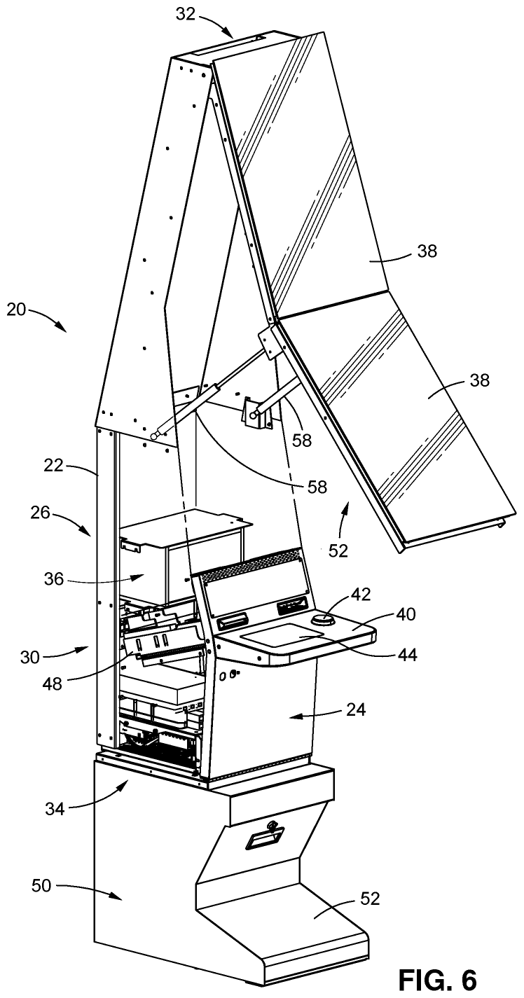

Referring to FIG. 6, the cabinet 22 generally defines an interior space 36 for internally housing components of the gaming machine 20. In this regard, the cabinet 22 is preferably constructed to have closed or solid faces (e.g., comprising the sides, back, etc.). In one configuration, for example, portions of the cabinet 22 may be constructed from sheet metal which is cut and/or bent into the desired shape. Those portions may then be connected, such as with fasteners (rivets, nuts and bolts), by welding or other joinder. As described in more detail below, access is preferably selectively provided to the interior space 36, such as for accessing the components therein.

Referring to FIG. 2, a width W of the cabinet 22 between at least one or more portions of the first and second sides 28,30 is preferably about 14 inches. In one configuration, the first and second sides 28,30 are substantially parallel, such that the width W of the cabinet 22 is generally constant (e.g., being the same at the front and back) at 14 inches. In other examples, as described below, the width W of the cabinet 22 may be 14 inches in one area, such as the rear of the cabinet 22, but have a different dimension at another area, such as the front. While the width W of the cabinet 22 is preferably 14 inches, it will be appreciated that the width need not be exactly 14 inches, but might be other substantially reduced dimensions (in relation to a standard gaming machine width of 28 inches, where a substantially reduced width is preferably 10-20% less, more preferably 20-50% less, and most preferably 50% less (or more)).

In the configuration of the gaming machine 20 illustrated in FIG. 1, first and second sides of the gaming machine 20 are co-extensive with the sides of the cabinet 22, whereby a total width of the gaming machine 20 is the same as the width of the cabinet 22. In other configurations described below, a total width of the gaming machine 20 might vary from the width of the cabinet 22.

A depth D of the cabinet 22 may vary, but in one configuration is 24-25 inches from the rear 26 to a front of a console 40 (described in more detail below). In such a configuration, it will be appreciated that the width of the cabinet 22 is less than the depth thereof, contrary to the configuration of a standard gaming machine (such as where the width is generally 28 inches, which exceeds a depth thereof at 18 inches).

In one example, a height (from top 32 to bottom 34) of the cabinet 22 of the gaming machine 20 may vary, such as depending on a number and/or configuration (such as height) of display devices used therewith, or other elements of the gaming machine 20. The height of the gaming machine 20 might vary depending upon whether the cabinet 22 is placed on a stand, the number and configuration of display devices (described below), etc. In one configuration, however, a height H1 of the cabinet 22 is preferably at least 4 times, and more preferably 5 or more times, the width W of the cabinet 22 and gaming machine 20 (e.g., H1/W>4 or 5). In one configuration, a total height H2 of the gaming machine 20, including a stand 50 (described in more detail below) is preferably at least 5 times, and more preferably 6 or more times, the width W of the cabinet 22 and gaming machine 20 (e.g., H2/W>5 or 6).

As illustrated in FIG. 1, the gaming machine 20 may include one or more display devices 38, such as at least one video display. At least one of the display device 38 may be located at the front 24 of the cabinet 22 (and thus the front of the gaming machine 20, such as facing outwardly for viewing by a player). In the example illustrated in FIG. 1, two display devices 38 (in this case, video displays) are provided, one above the other, with the displays arranged into different orientations (such as angles relative to vertical; wherein in this example, a lower display slopes rearwardly from bottom to top relative to vertical, and an upper display slopes forwardly from bottom to top relative to vertical). The gaming machine 20 might, as described in more detail below, include only a single display device or might include more than two, including one or more display devices which are not located at the front of the cabinet 22, but which might be supported by secondary mount (such as a topper mount) which is connected to or supported by the cabinet 22 (such as for supporting a display device above the top 32 of the cabinet 22).

The display devices 38 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g., 4:3, widescreen or the like). The display devices 38 may be capable of projecting or displaying a wide variety of information, including images, symbols and other indicia or information associated with game play, game promotion or other events.

In one configuration, for example, the display devices 38 comprise two vertically or “portrait” oriented video displays, each of which may have a 27-inch diagonal screen size.

While the display devices may comprise one or more video displays, (such as for presenting video poker, video slots or other video-based games) in another example, the gaming machine 20 may include one or more physical reels capable of displaying game information, such as slot symbols. In such a configuration, means are provided for rotating the physical reels. In one or more examples, the means may comprise a mechanical linkage associated with a spin arm, with movement of the spin arm (a “pull”) by a user causing the reels to spin. In such an arrangement, the reels are generally allowed to free-wheel and then stop. In another example, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

The gaming machine 20 is preferably configured to present one or more games upon a player making a monetary payment or wager. In this regard, as described in more detail below, the gaming machine 20 includes a mechanism or means for accepting monetary value.

In one example, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards. As detailed below, the gaming machine 20 preferably includes a mechanism or means for returning unused monetary funds and/or dispensing winnings to a player.

The gaming machine 20 preferably includes one or more player input devices. In one configuration, certain of the input devices may be associated with a console or deck 40. The console or deck 40 may extend outwardly from the front 24 of the cabinet 22 (in use, towards a player of the gaming machine 20 who is facing the front of the gaming machine 20). The console 40 may define a generally planar top surface at which one or more of the player input devices is located. For example, such player input devices might comprise one or more buttons 42, a touch screen 44 and/or other devices such as plunger mechanisms, a joystick, slider, etc. Further, the player input devices might include one or more input devices which are not associated with the console, such as a touchscreen which is associated with the display device 38. These one or more player input devices may be utilized by the player to facilitate game play, such as by providing input or instruction to the gaming machine 20. For example, such input devices may be utilized by a player to place a wager, cause the gaming machine 20 to initiate a game, to indicate cards to be held or discarded in a video poker game, to “cash out” of the gaming machine, or to provide various other inputs, such as depending upon the configuration of the game being presented by the gaming machine 20.

In one preferred example, the gaming machine 20 includes at least one microprocessor or controller for controlling the gaming machine, including receiving player input and sending output signals for controlling the various components or peripheral devices of the machine 20 (such as generating game information for display by the display devices 38). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by display devices 38 (such as information comprising game symbols (slot symbols, cards, dice, etc.) depending upon the game being presented by the gaming machine), for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g., in a fixed or non-transitory configuration. The memory may also store other information or data, such as data stored in table or other forms (including, but not limited to look-up tables, pay tables and other information, including tracked game play information). The gaming machine 20 may also include one or more random number generators for generating random numbers (such as implemented by a random number generator software module stored in the memory and executable by the processor or controller), such as for use in selecting slot symbols, cards or other game symbols and for presenting the game in a random fashion (e.g., whereby the game is presented in a manner in which the player cannot control the outcome) or pseudo-random fashion (e.g., such as where the game includes a skill component which can affect the outcome of the game).

Preferably, the controller is configured to execute machine readable code or instructions (e.g., software) which are configured to implement the game. In this regard, the gaming machine is specially configured to present one or more games via specific software and/or hardware which causes the gaming machine to operate uniquely. For example, the controller of the gaming machine 20 may be configured to detect a wager, such as a signal from a player's depressing of a game start button 42. Upon such an event and/or the player otherwise signaling the gaming machine to present the game, the controller may be configured to cause the display device 38 to display unique information, such as a unique graphical interface or unique game display, including game symbols or other game information (such as graphically represented images of cards, slot symbols, dice, etc.). The controller may accept input from a player of game inputs, such as a request to spin reels or the like, via the one or more player input devices of the gaming machine 20. As indicated above, the machine-readable code may be configured in various manners, such as by having various “modules” of software which are designed to implement specific features of the game play or game presentation.

The gaming machine 20 may be configured to generate and present games in a stand-alone manner or it may be in communication with one or more external devices at one or more times. For example, the gaming machine 20 may be configured as a server-based device and obtain game code or game outcome information from a remote game server (in which event the gaming machine controller may receive game information from the server, such as game outcome information, and use that server-generated information to present the game at the gaming machine). For example, the gaming machine 20 might be configured as a stand-alone device or as a server-based device for presenting games as Class III games (as defined by the U.S. Indian Gaming Regulatory Act) or as a server-based device for presenting games as Class II games (as defined by the U.S. Indian Gaming Regulatory Act).

The controller of the gaming machine 20 is preferably located in the interior 36 of the cabinet 22, to protect it from damage and tampering.

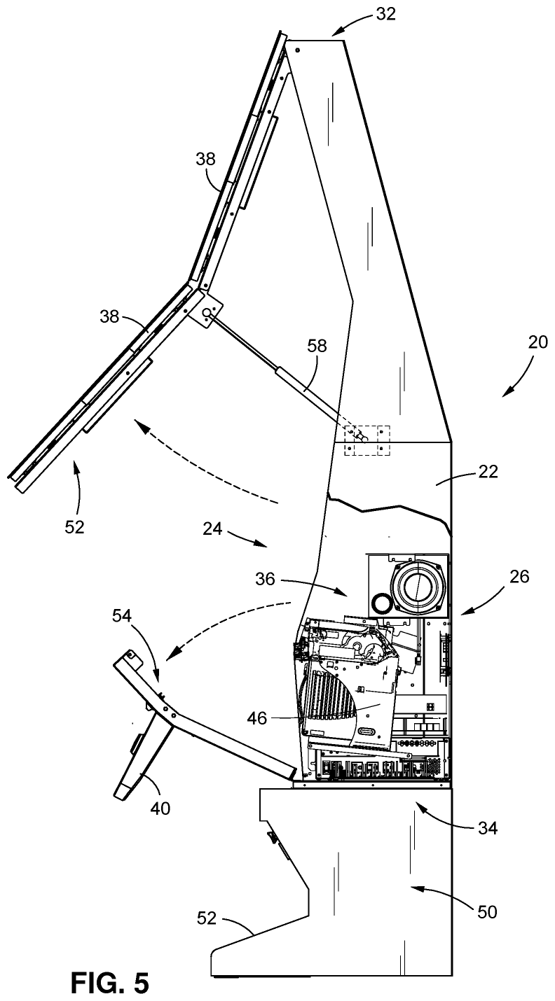

As indicated, the gaming machine 20 is preferably configured to present one or more wagering games. The gaming machines 20 is preferably configured to accept value, such as in the form of coins, tokens, paper currency or other elements or devices representing value such as monetary funds. Thus, as indicated above, the gaming machine 20 preferably includes a mechanism or means for accepting monetary value. For example, as illustrated in FIG. 5, the gaming machine 20 may include a media reader 46. Such a reader may be configured to accept and read/verify paper currency and/or other media such as tickets. Of course, in such event the gaming machine 20 may further be configured with one or more paper currency or ticket storage devices, such as cash boxes, and other paper currency or media handling devices (including transport devices). Although not illustrated, the gaming machine 20 might include a coin acceptor for accepting coins. Of course, associated coin reading/verifying devices and coin storage devices may be associated with the gaming machine 20 if it is configured to accept coins.

The gaming machine 20 might also be configured to read FOBs, magnetic stripe cards or other media having data associated therewith and via which value or funds may be associated with the gaming machine 20, such as a card reader or other reading device. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications links, such as to enable the transfer of funds from the player to the gaming machine or system).

When the player associates funds with the gaming machine or an associated system, a credit balance may be generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one example, when the player's wager is received, the player's credit balance is reduced by the number of wagered credits. The player might then provide a separate input to begin the game. In other example, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one example, the gaming machine 20 is configured to award winnings for one or more winning wagering game outcomes. Such winnings may be represented as credits, points or the like. In one example, the player may “cash out” and thus remove previously associated funds and any awarded winnings or such may otherwise be paid to the player. These winnings may be associated with the player's credit balance, thus increasing the player's credit balance.

In one example, the player may provide an input to the gaming machine 20 to indicate their desire to cash out, such as by selecting a “cash out” button (such as implemented via one of the buttons 42) or touch screen feature or providing other input. In response, a monetary value represented by the player's credit balance or the like is preferably paid, transferred or otherwise provided to the player. For example, upon an award or at cash-out, associated funds may be paid to the player by the gaming machine 20 by dispensing paper currency. In yet another example, a player may be issued a media, such as a printed ticket, such as by a media reading and printing device 48 as illustrated in FIG. 6, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another example, the cash-out might result in the dispensing of a card or other media which stores or represents the cashed-out funds, such as by writing funds information to a magnetic stripe of a card which is inserted into a media writer of the gaming machine or dispensed from the machine. In other examples, the cash-out mechanism may result in the funds value being transferred to an external device or account, such as a player's casino account (such as associated with a casino server), a remote bank or other financial account, or an electronic device such as a player's phone, PDA or tablet.

The gaming machine 20 may also include a player tracking device, such as may be configured to receive player loyalty account information. Such may comprise, for example, the card reader, a displayed keypad or other information receiving device(s). Such player tracking devices are well known and may permit the game operator to track play of players of the gaming machine. The tracked play may be utilized to offer player bonuses or awards.

In one example, the gaming machine 20 may include, or be configured to sit or rest upon, a stand 50. The stand 50 is preferably no wider than the cabinet 22, so as to not increase the footprint of the gaming machine 20, as described in more detail below. In one embodiment, the depth of the stand 50 may be around 18 inches at a top thereof and 23 inches at the bottom (a forwardly extending footrest area) thereof.

The stand 50 may have a top surface on which the gaming machine 20 may be supported. Of course, the gaming machine 20 might be connected to the stand 50 and/or the stand 50 might comprise an integrated portion of the cabinet 22 of the gaming machine 20.

The stand 50 may have a number of shapes, sizes and features. For example, as illustrated, the stand 50 may define a footrest 52, such as supporting surface for accepting the feet of a player. The stand 50 might also define an interior area that may be used for storage, to house equipment such as speakers, or the like.

Preferably, selective access is provided to the interior or interior space 36 of the cabinet 22. In one example, access may be provided through one or more doors or panels. Referring to FIG. 5, in one example, the gaming machine 20 has a top door 54 and a bottom or lower door 56.

In one configuration, the top and bottom doors 54,56 are configured to open and closed “clamshell style”, wherein a top of the top door 54 is hingedly or rotatably connected (such as via one or more hinges) to the cabinet 22 and a bottom of the bottom door 56 is hingedly or rotatably connected to the cabinet 22. In this configuration, the top door 54 can be rotated to a closed position in which a bottom thereof is adjacent to the front 24 of the cabinet 22 (thus closing a portion of the front 24 thereof), such as illustrated in FIGS. 1 and 2, and an open position, in which it is rotated outwardly therefrom, such as illustrated in FIG. 5. Similarly, the lower door 56 may be rotated so that in a closed position, a top thereof is adjacent to the front 24 of the cabinet 22 (thus closing a portion of the front 24 thereof), such as illustrated in FIGS. 1 and 2, and an open position, in which it is rotated outwardly therefrom, such as illustrated in FIG. 5.

As illustrated, the top door 54 may comprise at least a substantial portion of the front 24 of the cabinet 22, preferably from the top 32 thereof to the bottom door 56, which comprises the remainder of the front 24 thereof. In this configuration, the one or more display devices 38 may be connected to the top door 54, such as to be movable therewith. In the configuration illustrated, the console 40 is connected to and extends from the bottom door 56, and is thus movable therewith.

The “clam shell” configuration of the doors 54,56 has a number of advantages. One advantage is that the vertical opening and closing arrangement allows for a wide range of movement of the doors 54,56, as compared to side opening doors where, particular in narrow-width configuration of the gaming machine 20 of the present disclosure, side opening doors would be limited in opening travel distance. Thus, the clam-shell arrangement permits the doors 54,56 to be opened a wider distance, thus providing better access to the interior 36. Further, while a single large door might be utilized, such a door if opening downwardly, would extend far out from the gaming machine and thus impede a technician trying to access the machine and impacting travel lanes near the gaming machine during in-casino service. Further, the fulcrum effect of such a door would cause extreme loads on the door when opened. Similar problems would exist if a single tall door were provided that opened upwardly. The clam-shell configuration effectively creates smaller doors that eliminate these problems, but which cooperate to effectively act as a single door. Further, in some cases, either the top or bottom door 54,56 may be configured to be opened independently of the other, providing more controlled access to the interior space 36.

One or more means may be used to assist in the opening and/or closing of the top door 54 and/or bottom door 56. For example, as illustrated in FIG. 5, at least one shock 58 (such as a gas/pneumatic shock) may be used to assist in opening the door and in closing the top door 54 (such as to prevent it from slamming closed).

One or more latches and/or locks may be used to maintain the top door 54 and bottom door 56 in their closed positions. For example, at least one latch may be engaged when the top door 54 and bottom door 56 are closed, and that latch may include a locking mechanism or a separate locking mechanism may be provided. The locking mechanism may be configured to prevent unauthorized opening of the top door 54 and/or bottom door 56 (such as without a key, etc.).

As illustrated in FIGS. 5 and 6 and as indicated above, a number of components of the gaming machine 20 may be housed in the interior space 36 of the cabinet 22. These components may be accessed by opening the doors 54,56.

For example, as noted above, the gaming machine's controller or processor is preferably located in the interior space 36. Various sound-generating elements such as speakers, a sub-woofer or the like may be located therein. One or more cooling elements, such as fans or blowers, may be located in the interior space 36, such as configured to draw cool air from outside of the cabinet 22 through one or more vents into the interior space 36 and/or to expel heated air from inside of the cabinet 22 through one or more vents to the exterior of the cabinet 22.

As illustrated, the media reader (such as the ticket/bill validator) 46 may be located at one side of the cabinet 22 in the interior space 36. The media reader 46 may have an input slot which is aligned with a slot or opening 60 in the bottom door 56 (when the bottom door 56 is in its closed position), such as near the console 40.

Likewise, the printer 48 may be located at an opposing side of the cabinet 22 in the interior space 36. The printer may have a dispensing slot which is aligned with a second slot or opening 62 in the bottom door 56, such as near the console 40.

Elements of the gaming machine 20 may be supported by the bottom 34 of the cabinet 22, and/or the sides 28,30 or rear/back 26, within the interior space 36. For example, as illustrated, elements of the gaming machine 20 may be stacked generally vertically.

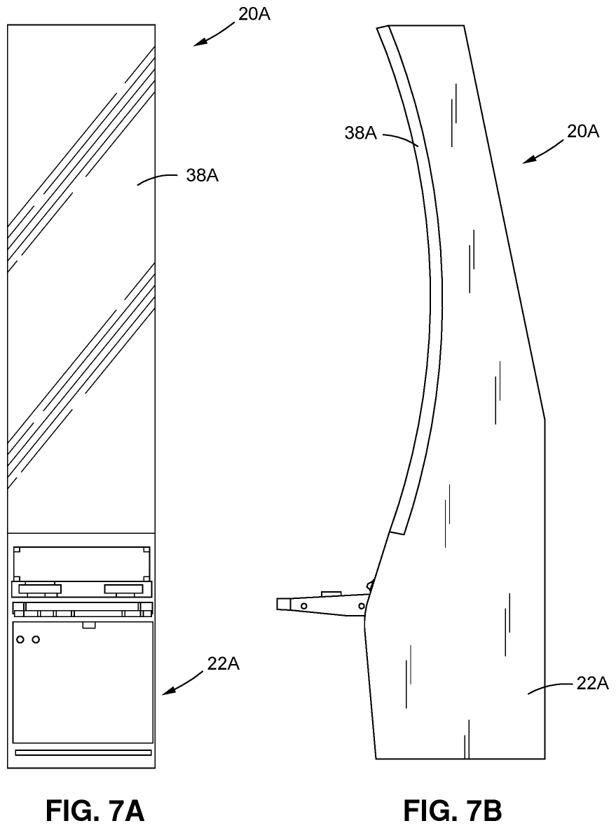

As indicated above, the gaming machine of the disclosure may have a number of configurations, including different arrangements of display devices 38, such as video displays. For example, FIGS. 7A and 7B illustrate a gaming machine 20A having a single large, curved video display 38A, instead of the two video displays of the gaming machine illustrated in FIGS. 1 and 2. This single video display 38A might be mounted to the top door of the cabinet 22A and be movable therewith. Again, in this configuration, the gaming machine 20, including the cabinet 22A thereof, has a reduced width-wise dimension. FIGS. 7A and 7B just illustrate one other example configuration of at least one display device that may be utilized, but it will be appreciated that many others may be utilized.

In one example, the display device(s) 38 and/or other features of the gaming machine 20 are configured so that the maximum width of the gaming machine 20 is the same as that of the cabinet 22. For example, in the configuration illustrated in FIGS. 1 and 2, the width of the video displays 38 are the approximately the same as—or less—than the width of the cabinet 22, as is the console 40, stand 50, etc. However, in other configuration, as detailed below, the cabinet 22 might have a first width (or maximum width) which is different from, such as less than, the maximum width of the gaming machine 20.

As indicated above, an important aspect of the disclosure is the reduced width-wise dimension of the gaming machine 20, such as where maximum width of the gaming machine 20 (including the cabinet 22) is about 14 inches. In comparison to standard gaming machines which generally have a width of at least 28 inches, this configuration has a number of advantages.

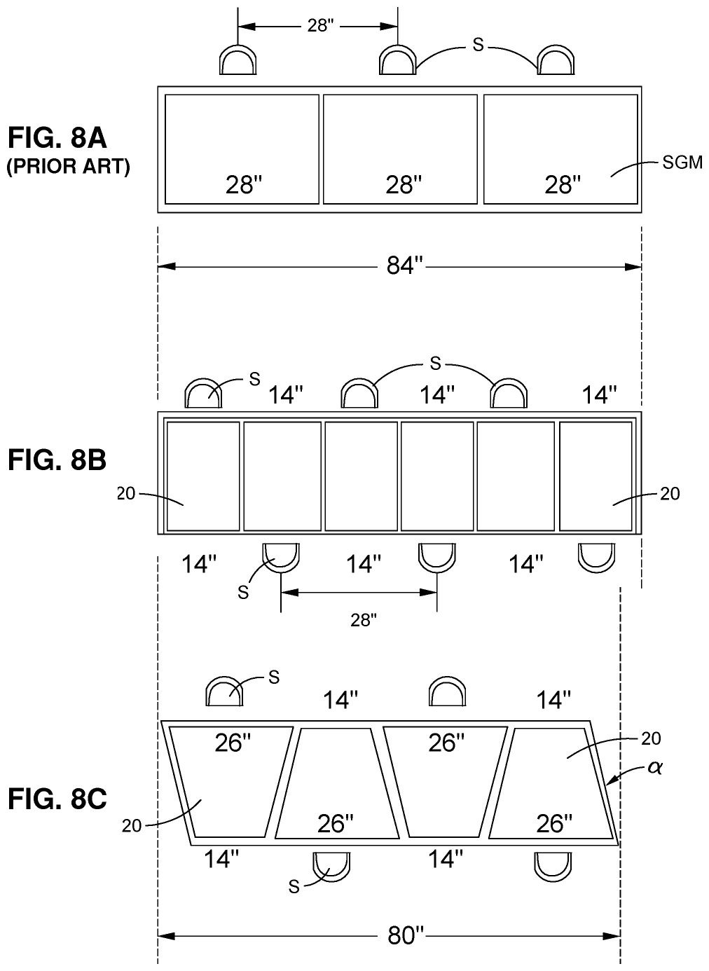

FIG. 8A illustrates an exemplary configuration of standard gaming machines (SGM) (which have a cabinet with generally planar sides that form the sides of the gaming machine, where the width from side to side is generally at least 28 inches) on a casino floor. In this example, three (3) standard gaming machines SGM are shown in side-by-side relationship with associated seats S. As illustrated, in such a configuration, these three (3) standard gaming machines would span 84 inches of casino floorspace in the widthwise direction. Each player is separated from a player of an adjacent gaming machine by 28 inches (less the space occupied by the players themselves).

On the other hand, as illustrated in FIG. 8B, six (6) gaming machines 20 of the present disclosure may be placed in that same amount of width-wise space, doubling the number of gaming machines that the casino can provide for play in the same space. As illustrated, in order to provide an increased space between the players of the gaming machines, the front of the gaming machines 20 may alternately face in opposing directions, thus providing the players of the gaming machines the same space between themselves and an adjacent player as is provided between players of the standard gaming machines as illustrated in FIG. 8A.

As described above, in some configurations, the cabinet 22 may have a varying width, such as where the cabinet 22 has different a different width at the front and at the rear thereof. FIG. 8C illustrates an example where the cabinet 22 of a gaming machine 20 has a width of about 14 inches at the rear thereof, but a greater width, such as 26 inches, at the front thereof. In such a configuration, as illustrated, the cabinet 22 has a generally trapezoidal horizontal cross-sectional shape, where the sides 28,30 of the cabinet 22 angle inwardly moving from the front to the rear of the cabinet, such as at an angle α of approximately 25-35 degrees, and most preferably about 31 degrees.

In this configuration, adjacent gaming machines 20 may again be arranged to face in opposing directions—e.g., wherein the front of one gaming machine is located adjacent to the rear of the next. In such a configuration, the sides of adjacent gaming machines, while extending at an angle from front to rear, are parallel to one another (and as illustrated, adjacent sides of the gaming machines essentially overlap when considering a line extending perpendicular to the row of gaming machines). This permits four (4) gaming machines 20 to be placed in the same 84-inch width-wise space in the casino-again a substantial increase in the number of gaming machines in the same space as compared to an arrangement of conventional gaming machines as illustrated in FIG. 8A. Other arrangements of gaming machines 20 might be provided with cabinets 22 having a reduced rear dimension in relation to other portion, such as the front, other than trapezoidal. When such a gaming machine 20 is associated with a stand, the stand preferably has a similar cross-sectional shape (and dimensions), or where the stand has sides that extend parallel to one another, the sides are spaced apart by a distance no greater than the minimum width of the cabinet 22.

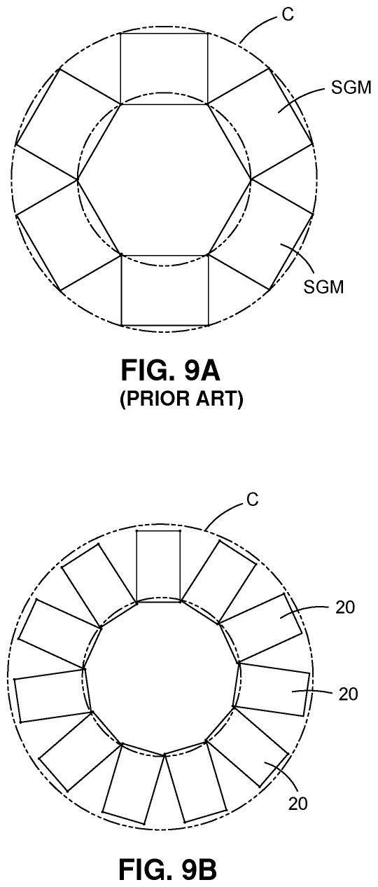

Likewise, as illustrated in FIG. 9A, standard gaming machines (SGM) of the prior art (e.g., having a width of 28 or more inches) might be arranged in a circular or carousel arrangement. As illustrated, therein relative to a circular space having a circumference C, a maximum of six (6) such standard gaming machines may be located in the circular space. However, as illustrated in FIG. 9B, a total of eleven (11) gaming machines 20 of the present disclosure (having a constant width of 14 inches) may be located in the same area. This permits a casino to offer, relative to the same amount of floor space, an 83% greater number of gaming machines to players than could be previously offered.

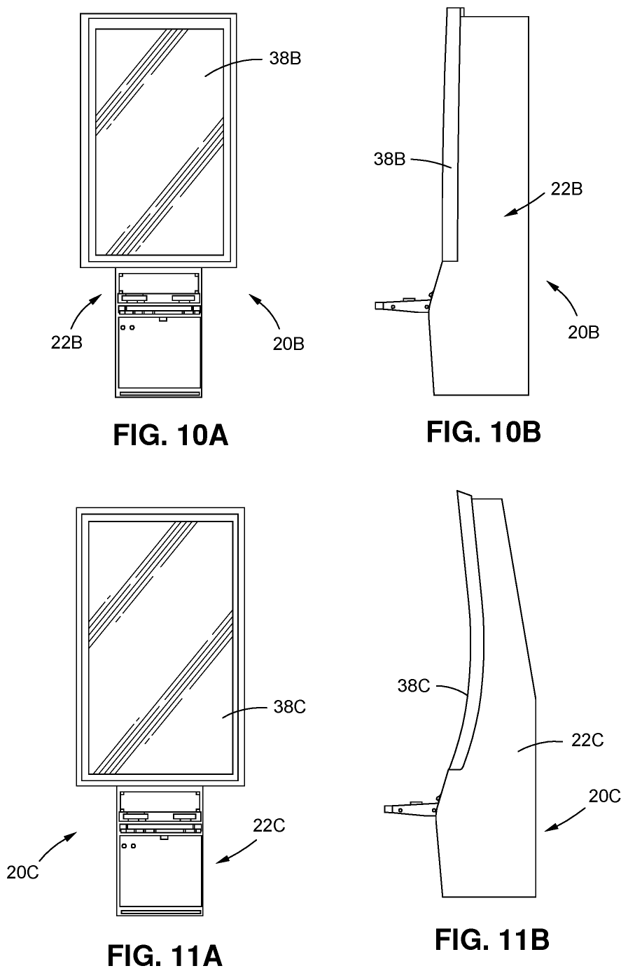

As described above, in some configurations, the cabinet 22 of the gaming machine 20 may have a first reduced width dimension, while the gaming machine 20 has a different width. For example, FIGS. 10A and B illustrate a gaming machine 20B which has a reduced width cabinet 22B (such as 14 inches), but a single generally planar video display 38B which has a greater width dimension, such as 28 inches, thus causing the total width of the gaming machine 20B to be about 28 inches. However, as described below, the location portion of the gaming machine with the greatest width—e.g., the video displays(s) 38B at the front of the gaming machine (excluding the console), whereby the rear of the gaming machine 20B still has a reduced dimension (due to the narrow cabinet) still results in a number of advantages, including space-savings.

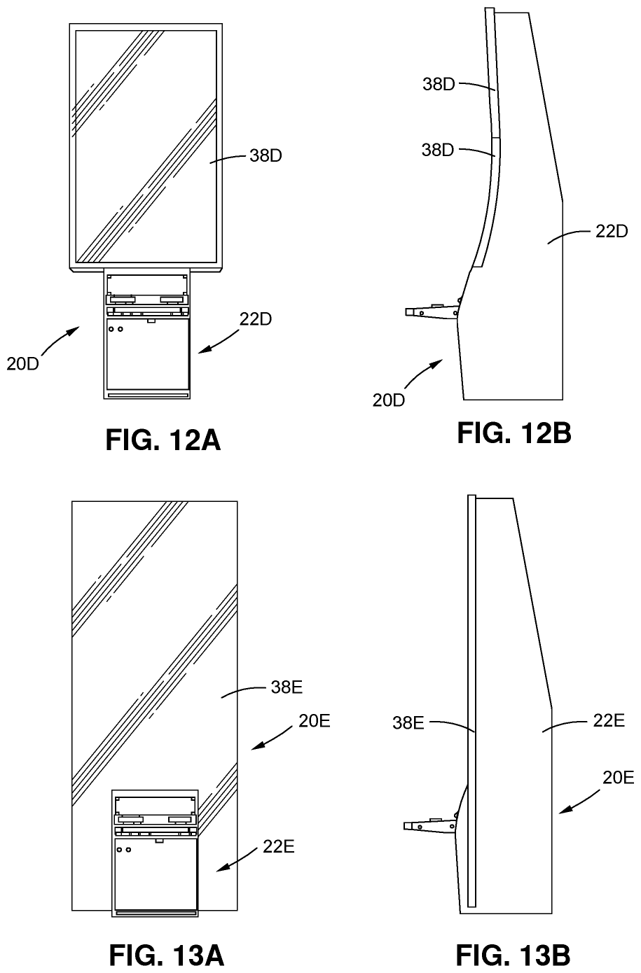

FIGS. 11A and B illustrates a similar example where the gaming machine 20C has a total width which is greater than that of the cabinet 22C, such as due to the width of a single curved video display 38C. FIGS. 12A and B illustrate yet another example where the gaming machine 20D has a total width which is greater than that of the cabinet 22D, such as due to the width of first and second curved video displays 38D. In each of these configurations, the video displays may be associated with just a top portion of the cabinet thereof, such as by being connected to a top door. However, as illustrated in FIGS. 13A and B, in another configuration, one or more video displays 38E or other display devices may extend outwardly beyond other portions of the cabinet 22E, such as including the bottom portion thereof. In this configuration, portions of the one or more video displays 38E are located at or extend outwardly beyond, the sides of the cabinet 22E at the bottom thereof (and thus cause the gaming machine 20E to have a total width which exceeds that of the cabinet 22E).

However, even in a configuration where the gaming machine of the disclosure has a total width which exceeds that of the cabinet itself, the narrow configuration of the cabinet allows for more efficient use of casino floor space—namely, placement of a greater number of gaming machines in a given area.

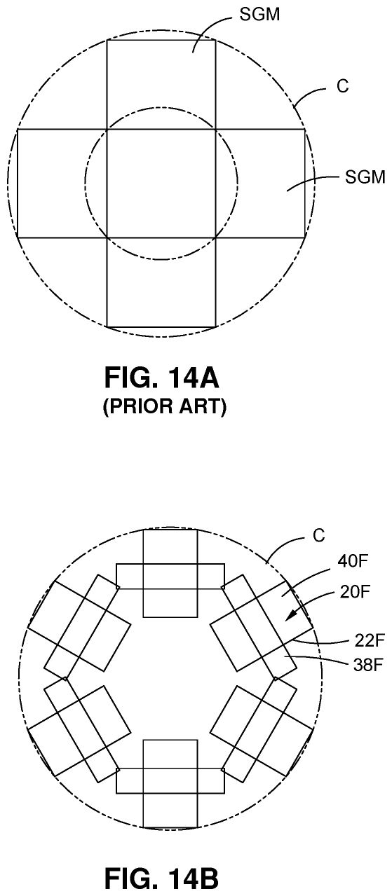

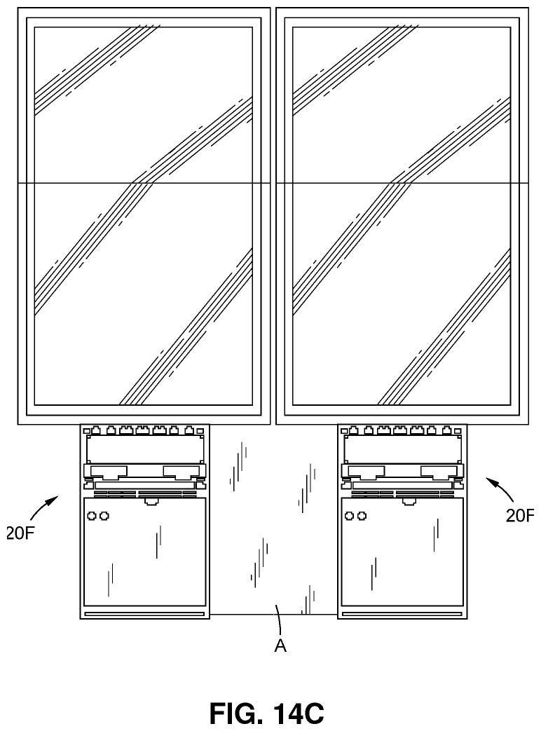

For example, as illustrated in FIG. 14A, standard gaming machines (SGM) of the prior art (e.g., having a width of 28 or more inches) might be arranged in a circular or carousel arrangement. As illustrated, therein relative to a circular space having a circumference C, a maximum of four (4) such standard gaming machines may be located in the circular space. However, as illustrated in FIG. 14B, a total of six (6) gaming machines 20F of the present disclosure-which may have a configuration such as that illustrated in FIGS. 10A-B, 11A-B, 12A-B and/or 13A-B, may be located in the same area. This permits a casino to offer, relative to the same amount of floor space, an 50% greater number of gaming machines to players than could be previously offered.

In particular, as illustrated in FIG. 14B, while the overall width of the gaming machines 20F is greater than that of the cabinets 22F, the location of the wider portion of the gaming machines 20F—namely the one or more displays 38F (forwardly of the rear of the cabinet 22F but behind the console 40F), causes the widest portion of the gaming machine 20F to be located forwardly of a rear of the gaming machine 20F. As illustrated, this narrower rear width of the gaming machines 20F at the rear of the cabinet 22F allows a greater number of gaming machines 20F to be placed in the same space.

As illustrated in FIG. 14C, such gaming machines 20F might also be placed side by side. In such a configuration a space A is generated between the two reduced width cabinets 22F of the gaming machines 20F. An additional display, advertising platform or other elements might be located in this newly created space (which does not exist between standard gaming machines).

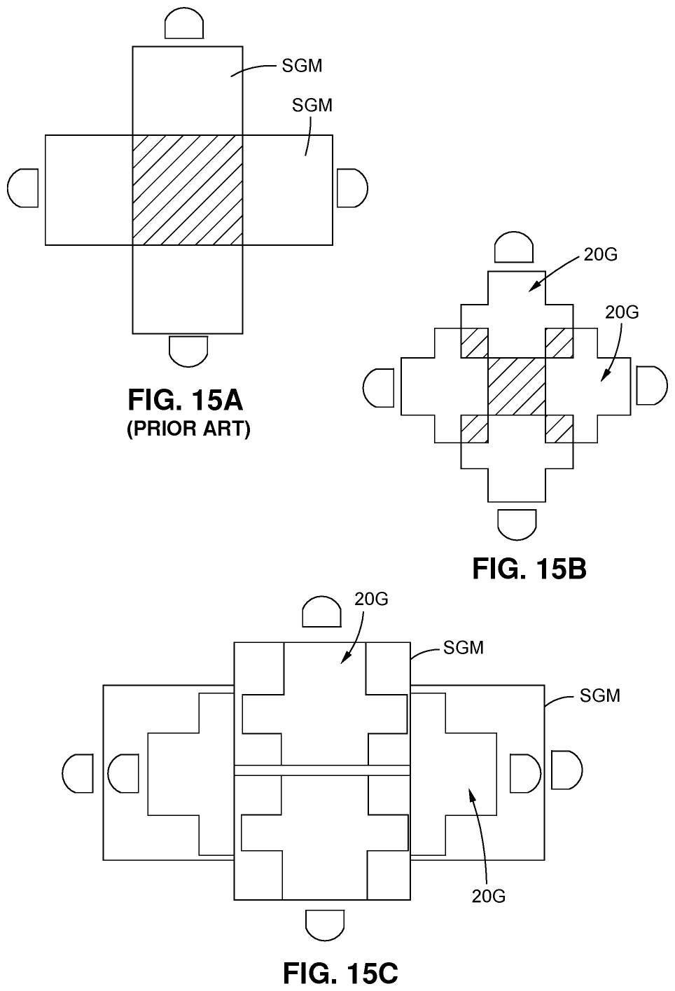

Another example of the space-savings configuration of gaming machines of the disclosure is illustrated with reference to FIGS. 15A-C. FIG. 15A shows a configuration of standard gaming machines (SGM) of the prior art (e.g., having a width of 28 or more inches), arranged into a “+” pattern of four (40) machines. As illustrated, due to the size of the cabinets of those machines, a large dead space is located behind those machines. The four standard gaming machines occupy approximately 23.3 SF of casino floor space (not counting the seats).

FIG. 15B illustrates how four (4) gaming machines 20G of the present disclosure-which may have a configuration such as that illustrated in FIGS. 10A-B, 11A-B, 12A-B and 13A-B, may be arranged in a similar pattern. In this configuration, the reduced size of the gaming machines 20G causes each of them to occupy less floor space, but also allows them to be placed closer together, thus occupying only 12.8 SF of floor space-a 45% reduction in space.

FIG. 15C illustrates another comparison where four (4) standard gaming machines (SGM) are arranged into a “cross” pattern, as are four (4) gaming machines 20G of the present disclosure. In this configuration, the standard gaming machines occupy approximately 18SF of casino floor space, while the gaming machines 20G of the disclosure only occupy 10.5 SF of floor space.

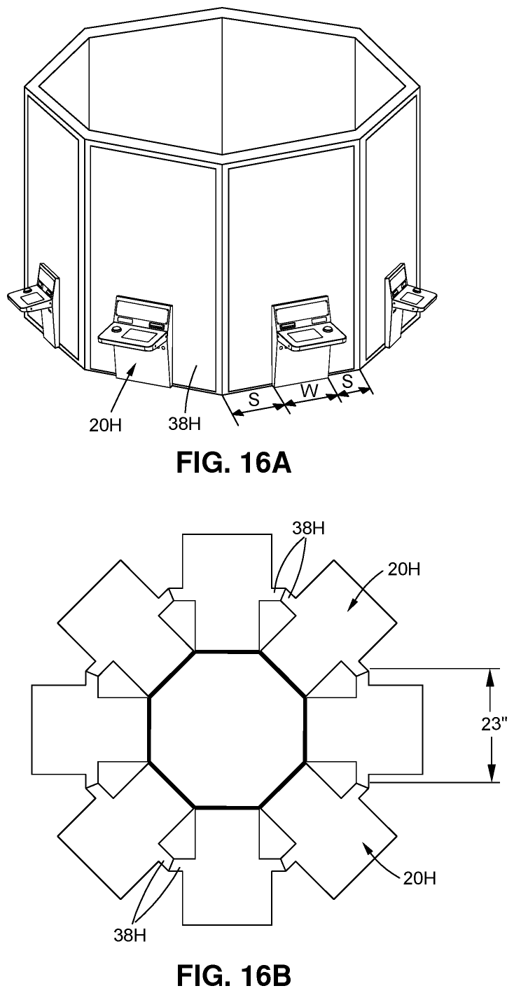

Principles of the disclosure may be applied to create other configurations of gaming machines, or combinations thereof. For example, as illustrated in FIGS. 16A and B, gaming machines 20H of the present disclosure may be arranged in a ring or circular shape. The configuration of the gaming machines 20H permits the video displays 38H thereof to be arranged in a connecting or contiguous fashion—e.g., so that there is effectively no gap or space therebetween. This is in contrast, for example, to the arrangement of standard gaming machines, such as in FIGS. 9A and 14A.

In particular, in accordance with the gaming machine 20H of the present disclosure wherein the width of the cabinet 22H is reduced, particularly in relation to the width of the one or more display devices 38H, the gaming machines 20H can be arranged so that the edges of the display devices 38H of adjacent gaming machines touch/contact. This allows the display devices 38H of the gaming machines 20H to appear essentially as a single contiguous display.

In configuration, to facilitate integration of the display devices 38H of the different gaming machines 20H, where the display devices 38H comprise video displays, the frame or similar features along the edges thereof may be removed so that the display portions of the video displays are positioned adjacent to one another/contact, without any intermediate or interrupting frame elements. Further, as illustrated in FIG. 16B, the edges of the video displays might be angled or chamfered so that they are parallel to one another.

In one preferred configuration, the distance that the video display extends outwardly from both sides of the cabinet 22H, identified as distance “S” in FIG. 16A, is preferably greater than the width of the cabinet 22H, identified as distance “W” in FIG. 16A. In other words, 2*S≥W, such that if W is 14 inches, S≥inches.

In some embodiments, adjacent gaming machines of the disclosure may be connected, such as with fasteners or other elements. Such connections may be used to increase the stability thereof, such as to prevent the gaming machines from tipping over (such as due to their narrower configuration).

It will be understood that the above-described arrangements of apparatus and the method there from are merely illustrative of applications of the principles of this disclosure and many other examples and modifications may be made without departing from the spirit and scope of the disclosure as defined in the claims.

What is claimed is:

1. A gaming machine comprising:
a housing having a front, a rear, a first side and a second side, said housing defining a generally enclosed interior area;
at least one display located at said front of said housing;
a console located at said front of said housing and extending outwardly from said front of said housing;
at least one player input device associated with said console;
a gaming controller and a memory located in said interior area, and machine-readable code stored in said memory and configured to cause said gaming controller to present at least one wagering game to a player of said gaming machine comprising causing said at least one display to display information regarding said wagering game; and
wherein a width of said housing between said first and second sides at said rear between said sides is approximately one-half a width of said housing between said first and second sides at said front.

2. The gaming machine in accordance with claim 1, wherein said first and second sides of said housing angle inwardly from said front to said rear at an angle of between about 25-35 degrees.

3. The gaming machine in accordance with claim 2, wherein said first and second sides angle inwardly at an angle of about 31 degrees.

4. The gaming machine in accordance with claim 1, wherein said width of said housing between said first and second sides at said rear is approximately 14 inches.

5. The gaming machine in accordance with claim 1, wherein said housing is generally trapezoidal in horizontal cross-section.

6. An arrangement of at least two gaming machines comprising:
a first gaming machine and a second gaming machine each comprising:
a housing having a front, a rear, a first side and a second side, said housing defining a generally enclosed interior area;
at least one display located at said front of said housing;
a console located at said front of said housing and extending outwardly from said front of said housing;
at least one player input device associated with said console;
a gaming controller and a memory located in said interior area, and machine-readable code stored in said memory and configured to cause said gaming controller to present at least one wagering game to a player of said gaming machine comprising causing said at least one display to display information regarding said wagering game;
wherein said housing has a generally trapezoidal horizontal cross-section with said front of said housing being wider than said rear of said housing; and
wherein said first and second gaming machines are located side-by-side with a front of said housing of said first gaming machine positioned adjacent to said rear of said housing of said second gaming machine.

7. The arrangement of at least two gaming machines of claim 6, wherein a first side of said housing of said first gaming machine extends inwardly at an angle from said front to said rear of said housing of said first gaming machine and a first side of said housing of said second gaming machine extends inwardly at an angle form said front to said rear of said housing of said second gaming machine, and said first side of said housing of said first gaming machine and said first side of said housing of said gaming machine are located proximate to one another and extend generally parallel to one another.

8. The arrangement of at least two gaming machines of claim 6, wherein the rear of said housing of said first gaming machine and the rear of said housing of the second gaming machine are no more than about 14 inches wide.

9. A gaming machine comprising:
a housing having a front, a rear, a first side and a second side, said housing defining a generally enclosed interior area;
a video display located at said front of said housing, said video display having a width between first and second sides of said video display;
a console located at said front of said housing and extending outwardly from said front of said housing;
at least one player input device associated with said console;
a gaming controller and a memory located in said interior area, and machine-readable code stored in said memory and configured to cause said gaming controller to present at least one wagering game to a player of said gaming machine comprising causing said at least one display to display information regarding said wagering game; and
wherein a width of said housing between said first and second side is approximately one-half of the width of said video display.

10. The gaming machine in accordance with claim 9, wherein said video display has a bottom and said housing extends downwardly below said bottom of said video display.

11. The gaming machine in accordance with claim 9, wherein at least a portion of said video display extends outwardly from each of said first and second sides of said housing.

12. The gaming machine in accordance with claim 9, wherein said housing has a bottom and a bottom of said video display extends to said bottom of said housing.

13. The gaming machine in accordance with claim 9, wherein said video display has a generally planar front.

14. The gaming machine in accordance with claim 13, wherein said video display has a curved front.

15. An arrangement of gaming machines comprising:
a first gaming machine and a second gaming machine each comprising:
a housing having a front, a rear, a first side and a second side, said housing defining a generally enclosed interior area;
a video display located at said front of said housing, said video display having a width between first and second sides of said video display;
a console located at said front of said housing and extending outwardly from said front of said housing;
at least one player input device associated with said console;
a gaming controller and a memory located in said interior area, and machine-readable code stored in said memory and configured to cause said gaming controller to present at least one wagering game to a player of said gaming machine comprising causing said at least one display to display information regarding said wagering game;
wherein a width of said housing between said first and second side is approximately one-half of the width of said video display; and
wherein said first and second gaming machines are arranged adjacent to, and at an angle to, one another with a first side of the video display of the first gaming machine located adjacent to a second side of the video display of the second gaming machine.

16. The arrangement in accordance with claim 15, comprising six gaming machines located in a generally circular layout having a center, a rear of each of said six gaming machines facing said center.

17. A gaming machine comprising:
a housing having a front, a rear, a first side and a second side, said housing defining a generally enclosed interior area;
at least one display located at said front of said housing;
a console located at said front of said housing and extending outwardly from said front of said housing;
at least one player input device associated with said console;
a gaming controller and a memory located in said interior area, and machine-readable code stored in said memory and configured to cause said gaming controller to present at least one wagering game to a player of said gaming machine comprising causing said at least one display to display information regarding said wagering game; and
wherein said gaming machine has a width defined by a width of said housing between said first and second sides, and a height, wherein said height of said gaming machine is at least 5 times said width of said gaming machine.

18. The gaming machine in accordance with claim 17, wherein said first and second sides of said housing extend generally parallel to one another and said width is approximately 14 inches.

19. The gaming machine in accordance with claim 17, wherein said housing is located on a stand and a height of said gaming machine includes said stand.

20. The gaming machine in accordance with claim 19, wherein said stand has a stand width between first and second sides thereof which is generally the same as said width of said housing.
